(19) United States
(12) Patent Application Publication
(10) Pub. No.: US 2006/0247121 A1
(43) Pub. Date: Nov. 2, 2006

(54) Manufacturing method of activated carbon structure having a frame

(76) Inventor: Jong-Seob Shim, Kwangju (KR)

Correspondence Address: IPLA P.A., 3580 WILSHIRE BLVD., 17TH FLOOR, LOS ANGELES, CA, 90010, US

(21) Appl. No.: 10/545,832

(22) PCT Filed: Feb. 16, 2004
(86) PCT No.: PCT/KR04/00307

§ 371 Date: Aug. 17, 2005

(30) Foreign Application Priority Data
Feb. 17, 2003 (KR) 20-2003-0004510
Sep. 4, 2003 (KR) 10-2003-0061671

(51) Int. Cl. B01J 29/04

(52) U.S. Cl. 502/60

(57) ABSTRACT

Disclosed is a method for manufacturing an activated carbon structure having an excellent absorption capability and strength. The method includes the steps of adding a carbon fiber as a reinforcing material in an activated carbon, molding an activated carbon mixture mixed with the activated carbon having the carbon fiber and pitch as a binder in a mold having a frame, and carbonating the activated carbon mixture, so that the activated carbon structure includes the frame. The frame is made by a metal to be proof against the carbonating step of the activated carbon mixture and has various shapes according to purposes.

### TECHNICAL FIELD

The present invention relates to a method for manufacturing an activated carbon structure having a frame capable of an excellent adsorption and strength.

### BACKGROUND ART

Activated carbon has a large specific surface area (about 1500 m²/g) because it contains a lot of micro pores, so that it is widely used to remove an organic material included in fluid such as air, water, and etc.

There are some disadvantages when the activated carbon is used. First, it is necessary to use a package or a cartridge by using a net and the like for holding the activated carbon in a state of particle. In this case, a pressure drop of an adsorption and reaction apparatus is occurred, because it is difficult to control a packing factor of the activated carbon in the package or the cartridge. Further, the activated carbon should be filled in a cartridge to be used as an adsorption material or a catalyst support and is easily blown in a wind. Furthermore, when the activated carbon is used in a continuous process, it is generally filled in a special apparatus for easily separating after deactivation, but as the particle of the activated carbon is so small, a pressure drop of the apparatus should be generated.

To overcome some disadvantages as mentioned above, many trials are performed: a filter-type structure like a honeycomb shape is fabricated by using a binder; and a particle size of the activated carbon is increased. When the binder is used for manufacturing the activated carbon structure, the binder may block micropores thereof and reduce a specific surface area of the structure, thereby deteriorating an adsorption capability. For example, even if the steps of mixing activated carbon power with starch powder dissolved in water, forming an activated carbon structure, and drying the activated carbon structure are useful to form a special structure, the binder blocks micro pores of the activated carbon structure, so that a lower specific surface area may be reduced. Further, the method using the starch as a binder may not be used in a process having water or at above a combustion temperature of the starch.

As a bonding strength between the binder such as the starch and the activated carbon is weak, when the binder content is low, the activated carbon structure having the starch and the activated carbon can be easily breakable. When the binder content is high, a specific surface area of the activated carbon structure is low, thereby deteriorating an adsorption capability.

Therefore, a binder which can be convertible to carbon during a carbonating step is mixed with activated carbon power or grains, thereby converting the whole material having the binder and the activated carbon power or grains into carbon. This method can be performed at a relatively high temperature, so that a decrease of the specific surface area of the activated carbon structure is low. Namely, the binder is carbonated and is fixed at the activated carbon during the carbonating step, so that strength of the structure is kept and a decrease of a specific surface area of the structure is relatively low because some micro pores are generated during evaporating volatile components of the binder at a high temperature. Generally, the binder for this purpose is a thermoelastic resin or a thermoplastic resin.

Korean Patent No. 303,239 discloses a binder such as pitch or a thermoplastic resin to fix the activated carbon for manufacturing a carbon fiber filter-type adsorbent. When the pitch is used as a binder, heat treatment is performed at about 400° C. after mixing with the carbon fiber. During the heat treatment, the pitch is changed to a meso-phase and attached to the carbon fiber. However, during the heat treatment, as the pitch can be changed to a polymer resistant to heat, it is not expected to have micropores. Therefore, in case that an amount of the pitch is large or a thickness of the carbon fiber is thick, original micropores of the carbon fiber can be blocked and a deeper inside of micropores of the carbon fiber may not be activated. Thus, it is difficult to increase a specific surface area. In case that small amount of activated carbon powder is added, a tensile strength is high, but a decrease of a specific surface area is high.

Further, Korean Patent No. 302,472 discloses a method for changing to carbon from a binder by a heat treatment at high temperature, wherein a thermoelastic or a thermoplastic polymer is used as the binder, activated carbon powder is attached at an inorganic filter or a metal net by using the binder. In this case, an amount of the activated carbon powder to be attached to the metal net or the inorganic filter is limited. Further, as the thermoplastic polymer is stable to heat after hardening the thermoplastic polymer is hardened, a lot of energy and time may be needed to carbonate the stabilized thermoplastic polymer. Furthermore, a yield for carbonating of the thermoelastic or the thermoplastic polymer as the binder is low, thereby decreasing a specific surface area as increasing the amount of the binder. That is, though strength of an activated carbon structure is increased as increasing the binder, a specific surface area is decreased.

As described above, a binder according to conventional related arts is used for easily molding. In case that starch is used as a binder, the binder may block some micropores and decrease an adsoption capability of the activated carbon structure. In case that an activated carbon powder is attached to a structure by using a thermoplastic polymer as a binder, the thermoplastic polymer is decomposed by a preliminary heat treatment at a lower temperature and is carbonated at a higher temperature. In case of the former (using the starch), a heat treatment temperature may be different according to a characteristic of binders. In case of the latter (using the thermoplastic resin), it consumes a lot of time and energy for carbonating.

Further, as a temperature of a conventional method for manufacturing an activated carbon structure is high because it is difficult to mix an activated carbon and with a binder due to a high viscosity of the binder. A solvent is also used for dilution of the binder according to a conventional method. When the solvent is used, a carbonation step is not easy. Further, bubbles are generated during a heat treatment so that a formation of an activated carbon structure may not be good. As increasing a binder, strength of an activated carbon structure is high. However, the binder may block micropores of the activated carbon, thereby decreasing a specific surface area.

Therefore, it is highly needed to design an activated carbon structure which has a high tensile strength, is resistant to a high temperature, and has a high adsoption capability for enlarging an exchanging period for new one.

### DISCLOSURE OF INVENTION

It is therefore an object of the present invention to provide an activated carbon structure having a frame, wherein the structure has an excellent adsorption capability and strength.

It is therefore another object of the present invention to provide an activated carbon structure capable of manufacturing a various types such as a honeycomb shape, a plate shape, a rode shape, or the like.

To achieve the above described objectives, an activated carbon structure having a reinforcing frame in the structure is fabricated, so that a large size structure can be fabricated, strength of the structure is high. Further, a decrease of a specific surface area of the activated carbon structure is slight by using a mixture of pitch as a binder and activated carbon power.

According to an embodiment of the present invention, a method for manufacturing an activated carbon structure having a frame is provided, which includes the steps of: fabricating an activated carbon mixture mixed with about 100 weight(wt) portion of an activated carbon powder, about 5 to about 40 wt portion of a binder, and about 5 to about 30 wt portion of a reinforcing material; installing the frame having a predetermined shape in a mold; filling the activated carbon mixture between the mold and the frame; pre-heating the activated carbon mixture in the mold at about 50 to about 300° C. for about 10 to about 30 minutes; carbonating the activated carbon mixture about 400 to about 1000° C. for about 1 to about 15 hours in a furnace under an inert gas atmosphere; and cooling and activating the carbonated mixture while inputting steam or carbon dioxide under an inert gas atmosphere.

According to preferred embodiment of the present invention, the binder is one of tar, creosote oil, soft pitch, and hard pitch. The reinforcing material includes a carbon fiber having a length of about 1 to about 20 mm. The frame is one of iron, stainless steel, nickel, nickel alloy, aluminum, copper, and their mixtures. The frame is formed of a rough surface to increase adhesion strength and comprises of a surface layer having pitch above about a 0.1 mm thickness. The activated carbon mixture further includes a precursor to be used as a noble metal or a metal-oxide catalyst during the step of fabricating an activated carbon mixture and the noble metal or a metal-oxide catalyst is supported on the activated carbon structure.

### BRIEF DESCRIPTION OF DRAWINGS

The above objects and other advantages of the present invention will become more apparent by describing in detail preferred embodiments thereof with reference to the attached drawings in which:

FIG. 1 is a perspective view having partly vertical view showing a honeycomb-type activated carbon structure manufactured by using a metal perforated plate mold according to an embodiment of the present invention;

FIG. 2 is a perspective view of a honeycomb-type activated carbon structure having a frame of a metal rod according to an embodiment of the present invention;

FIG. 3 is a perspective view of an example of fixing a plurality of honeycomb-type activated carbon structures according to an embodiment of the present invention;

FIG. 4 is a perspective view of a stacked packing of a rod-type activated carbon structures according to an embodiment of the present invention;

FIG. 5 is separated perspective views of bottom and top molds of a honeycomb-type structure and a metal perforated plate mold according to an embodiment of the present invention;

FIG. 6 is an assembled perspective view of bottom and top molds of a honeycomb-type structure and a metal perforated plate mold according to an embodiment of the present invention, wherein an activated carbon mixture mixed with an activated carbon, a carbon fiber, and a binder is filled in the assembled mold; and

FIG. 7 is a perspective view for explanation of manufacturing a rod-type activated carbon structure according to an embodiment of the present invention.

### BEST MODE FOR CARRYING OUT THE INVENTION

Hereinafter, preferred embodiments of the present invention will be described in detail with reference to the accompanying drawings. It should be noted that like reference numerals are used for designation of like or equivalent parts or portion for simplicity of illustration and explanation.

According to an embodiment of the present invention, a method for manufacturing an activated carbon structure having a frame is provided, which includes the steps of: fabricating an activated carbon mixture mixed with about 100 weight(wt) portion of an activated carbon powder, about 5 to about 40 wt portion of a binder, and about 5 to about 30 wt portion of a reinforcing material; installing the frame having a predetermined shape in a mold; filling the activated carbon mixture between the mold and the frame; pre-heating the activated carbon mixture in the mold at about 50 to about 300° C. for about 10 to about 30 minutes; carbonating the activated carbon mixture about 400 to about 1000° C. for about 1 to about 15 hours in a furnace under an inert gas atmosphere; and cooling and activating the carbonated mixture while inputting steam or carbon dioxide under an inert gas atmosphere.

The step of preheating is for well penetrating the binder between the reinforcing materials. The step of carbonating should be performed under an inert gas such as a nitrogen gas or an argon gas for protecting fire because it is dangerous to be fired when a heat treatment of the carbonating step is performed under an oxygen gas. Further, the step of activating the carbonated mixture enlarges micropores of the activated carbon structure or removes unreacted materials on the surface of the activated carbon structure, thus a specific surface area and an adsoption ability are increased, thereby eliminating the step of activation by increasing a temperature of a conventional method.

According to a preferred embodiment of the present invention, the binder is one of tar, creosote oil, soft pitch, hard pitch, and their mixtures. The binder is a solid state or a liquid state and it can be used as a mixture of a solid state and a liquid state or a single state. Preferably, powder pitch having a softening point above a room temperature is used.

When the liquid pitch is used, a viscosity is an important process factor. The viscosity can be controlled by increasing a process temperature or mixing the pitch with heavy oil such as liquid creosote oil, thereby controlling fluidity between the activated carbon and the binder and easily mixing the activated carbon and the binder.

According to an embodiment of the present invention, when the binder is homogeneously distributed in the activated carbon powder, strength is constant and decrease of a specific surface area is low. The portion having a relatively high amount of the binder has a high strength but decrease of a specific surface area is high. The portion having a relatively low amount of the binder has a low strength but decrease of a specific surface area is low. According to an embodiment of the present invention, when pitch having a softening temperature above about 60° C. is used as a binder, the pitch can be easily mixed with the activated carbon and the reinforcing material because the pitch is in a powder state. When the homogeneously mixed activated carbon mixture is maintained above a softening temperature, the homogeneously distributed pitch powder is liquefied in the activated carbon mixture and is coated on the surface of activated carbon, the frame, and the reinforcing material. Thus, the structure has an excellent quality compared to the structure formed by using a liquid binder because the structure is formed by homogeneous mixing.

The coal tar pitch has a softening point of about 60˜100° C. a solid state in a room temperature, and an aromatic hydrocarbon mixture having a high molecular weight so that a boiling temperature is high. Further, a polymerization reaction of the coal tar pitch is easily occurred when the coal tar pitch is heated. The coal tar pitch includes benzene rings above three and a carbon-carbon bond so that a ratio of carbon to hydrogen is high having about 1.6˜1.9. Thus, it is highly changed to carbon when it is decomposed by a heat treatment so that it is suitable for a binder for the activated carbon structure. When the pitch is used as a binder, a volatile amount is small and the almost pitch is changed to carbon so that a yield of carbon transformation is high. Thus, even if a small amount of the pitch is used, the activated carbon structure strength can be promoted and the carbonation is performed during a short period. Further, a decrease of the specific surface area is small due to forming by evaporating volatile components during the carbonation step.

According to an embodiment of the present invention, the activated carbon structure having the frame further includes a carbon fiber having a length of about 1˜20 mm as a reinforcing material. As the carbon fiber is used as a reinforcing material, the activated carbon structure has a high strength compared to using only the binder.

According to an embodiment of the present invention, the frame is one of iron, stainless steel, nickel, nickel alloy, aluminum, copper, and their mixtures. Further, the frame is formed of a rough surface to increase adhesion strength and further includes a surface layer having pitch above about a 0.1 mm thickness. The rough surface increases a surface area thereby increasing adhesion strength between the frame and the activated carbon. The surface layer is formed by liquid pitch on the frame and changed to a carbon surface layer during the carbonation step, thereby maintaining adhesion strength with the activated carbon mixture 12.

In case that the frame is a rod-type 31, a diameter of the rod is about 1˜20 mm. In case that the frame is a net-type, the net is formed of about 0.1 mm thickness having about 10 mm circular or rectangular holes.

Further, a precursor to be used as a noble metal or a metal-oxide catalyst can be supported on the activated carbon structure during the step of fabricating an activated carbon mixture. The amount of the precursor can be controlled according to a purpose of the reaction and a temperature of the activated carbon mixture having the precursor is increased during the carbonating step. Then, the precursor is decomposed and the activated carbon structure can include the catalyst. That is, the step of supporting an active component of the catalyst can be eliminated, thereby increasing productivity and saving an energy and cost.

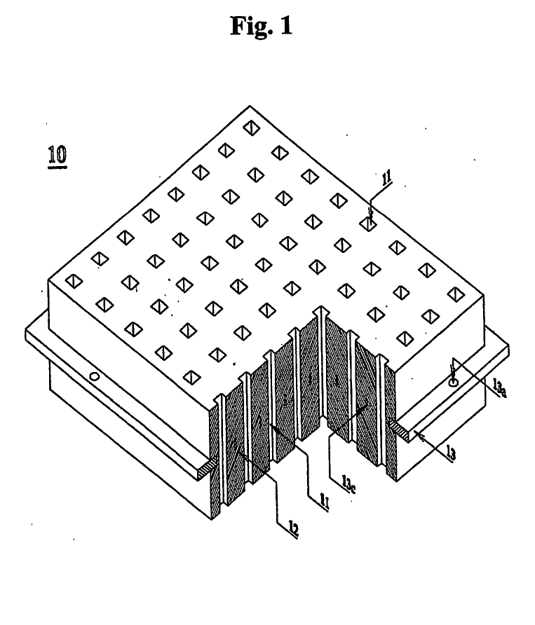

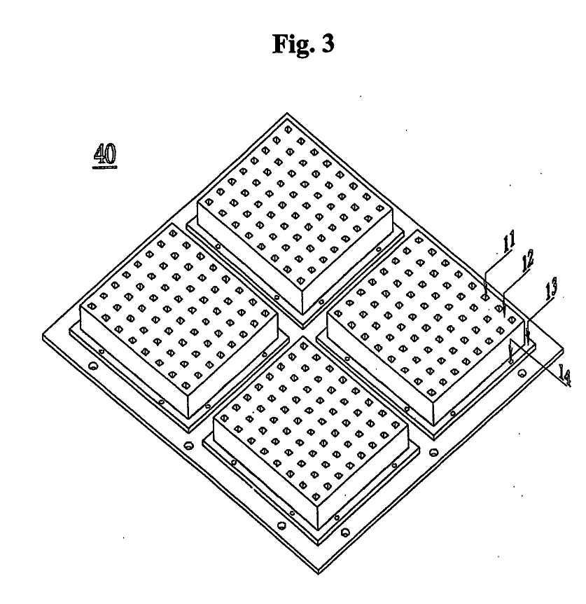

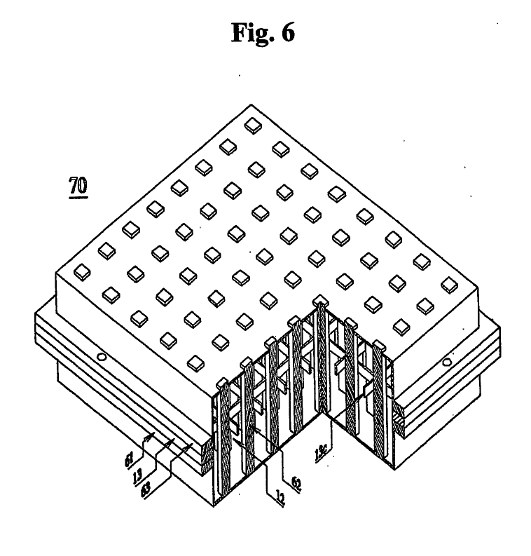

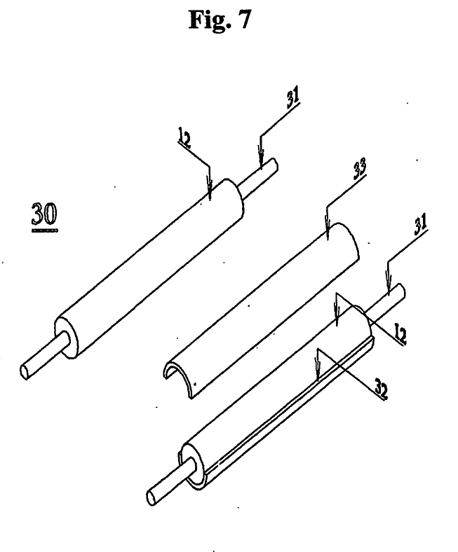

Hereinafter, Examples of the present invention will be described in detail below by using FIGS. 1 to 7.

### EXAMPLE 1

### Rod-Type Activated Carbon Structure

An embodiment of the present invention provides a method for manufacturing an activated carbon structure having a rod type frame 31. According to an embodiment of the present invention, the frame 31 is a rectangular or a round shape having a diameter of about 1 to about 20 mm. First, the frame was installed in a mold 32 or 33. Second, an activated carbon mixture mixed with about 100 weight(wt) portion of an activated carbon, about 15 to about 20 wt portion of a binder, and about 10 to about 15 wt portion of a reinforcing material was filled in the mold 32 or 33. Third, the mold 32 or 33 was removed and the activated carbon mixture was preheated at about 100° C. for about 10 minutes. And then, the preheated activated carbon mixture was carbonated and activated at about 400° C. for about 1 hour so as to manufacture a rod-type activated carbon structure.

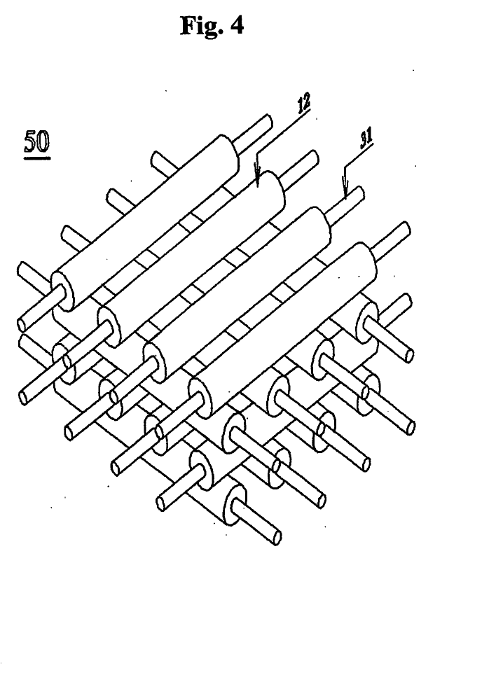

According to an embodiment of the present invention, an adsoption apparatus was provided, which includes the rod-type activated carbon structure intersecting each other filled in the adsoption apparatus as shown in FIG. 4, thereby reducing a pressure drop of the adsoption apparatus and increasing an adsoption amount.

### EXAMPLE 2

### Honeycomb-Type Activated Carbon Structure

An embodiment of the present invention provides a method for manufacturing a honeycomb-type activated carbon structure 10 or 20 having holes.

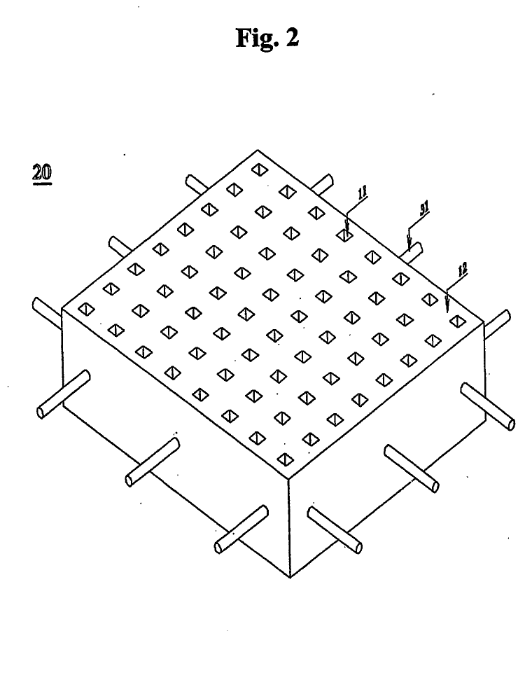

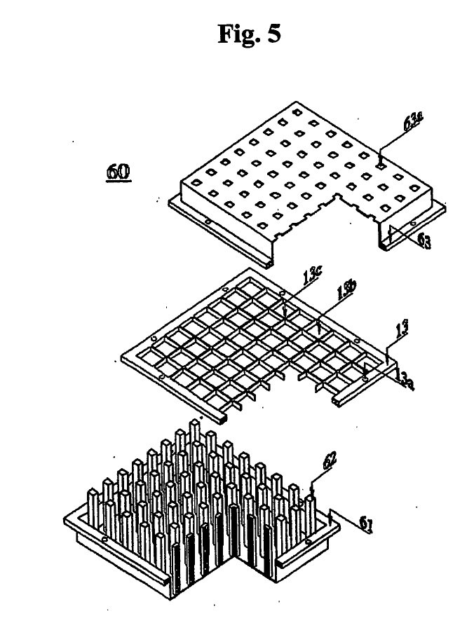

First, a metal net or a metal sheet 13 having holes 13b (in FIG. 5) was provided. According to an embodiment of the present invention, each size of the holes 13b is substantially the same as or larger than a cell size of an activated carbon structure or an air hole 11 (in FIGS. 1, 2, and 3). Second, an activated carbon mixture mixed with about 100 wt portion of an activated carbon, about 15 to about 20 wt portion of a binder, and about 10 to about 15 wt portion of a reinforcing material was filled in a honeycomb-type mold 61, 63 having a plurality of rods 62 therein. Each of rods will be used as air holes of the structure. Third, the mold 61, 63 was removed and the activated carbon mixture was preheated at about 100° C. for about 10 minutes. And then, the preheated activated carbon mixture was carbonated and activated at about 400° C. for about 1 hour to manufacture a honeycomb-type activated carbon structure (10 in FIGS. 1 and 20 in FIG. 2) having at least one air hole 11.

According to an embodiment of the present invention, the plurality of rods 62 in the honeycomb-type mold 61, 63 for forming air holes in the honeycomb-type activated carbon structure 10, 20 can be attached the bottom mold (61) and the top mold (63) includes a plurality of holes (63a). The plurality of rods 62 can pierce the top mold (63) through the plurality of holes (63a), thereby fixing the bottom mold (61). According to a preferred embodiment of the present invention, the plurality of rods (62) and the plurality of holes (63a) have a rectangular shape.

The honeycomb-type activated carbon structure 10 can be manufactured in a large size because the structure 10 can be manufactured according to a size of the metal net or the metal sheet 13.

As shown in FIG. 5, the structure 10 can be fixed by a fixing hole (13a in FIG. 5) of the metal sheet 13, thereby easily fixing in a conduit of an adsorption apparatus, a wall, and the like.

Although illustrative embodiments of the present invention have been described herein with reference to the accompanying drawings, it is to be understood that the invention is not limited to those precise embodiments, and that various other changes and modifications may be affected therein by one skilled in the art without departing from the scope or sprit of the invention.

### INDUSTRIAL APPLICABILITY

According to an embodiment of the present invention, the activated carbon mixture includes activated carbon powder or grains, a carbon fiber as a reinforcing material, pitch as a binder for binding the activated carbon power or grains to a metal frame. The activated carbon mixture is attached to the metal frame, and carbonated, thereby hardening an activated carbon structure having the mixture and the frame. Further, the activated carbon structure can be manufactured a large size according to a shape of the frame. Furthermore, it does not need a housing for fixing the activated carbon structure, thereby saving manufacturing cost and protecting a pressure drop by the housing. The activated carbon structure can have various shapes, easily attach or detach to an absorption apparatus, and have excellent strength, thereby saving manufacturing cost by lightening and simplifying the absorption apparatus.

What is claimed is:

1. A method for manufacturing an activated carbon structure having a frame, the method comprising the steps of:
fabricating an activated carbon mixture mixed with about 100 weight(wt) portion of an activated carbon powder, about 5 to about 40 wt portion of a binder, and about 5 to about 30 wt portion of a reinforcing material;
installing the frame having a predetermined shape in a mold;
filling the activated carbon mixture between the mold and the frame;
pre-heating the activated carbon mixture in the mold at about 50 to about 300° C. for about 10 to about 30 minutes;
carbonating the activated carbon mixture about 400 to about 1000° C. for about 1 to about 15 hours in a furnace under an inert gas atmosphere; and
cooling and activating the carbonated mixture while inputting steam or carbon dioxide under an inert gas atmosphere.

2. The method of claim 1, wherein the binder is one of tar, creosote oil, soft pitch, and hard pitch.

3. The method of claim 1, wherein the reinforcing material includes a carbon fiber having a length of about 1 to about 20 mm.

4. The method of claim 1, wherein the frame is one of iron, stainless steel, nickel, nickel alloy, aluminum, copper, and their mixtures.

5. The method of claim 1, wherein the frame is formed of a rough surface to increase an adhesion strength and comprises of a surface layer having pitch above about an 0.1 mm thickness.

6. The method of claim 1, wherein the activated carbon mixture further includes a precursor to be used as a noble metal or a metal-oxide catalyst during the step of fabricating an activated carbon mixture and the noble metal or a metal-oxide catalyst is supported on the activated carbon structure.

7. The method of one of claim 1 to claim 6, wherein the activated carbon mixture includes about 100 wt portion of an activated carbon powder, about 5 to about 40 wt portion of a binder, and about 5 to about 30 wt portion of a reinforcing material, wherein the binder is one of tar, creosote oil, soft pitch, hard pitch, and their mixtures, wherein the reinforcing material includes a carbon fiber having a length of about 1 to about 20 mm.
